(19) United States
(12) Patent Application Publication
(10) Pub. No.: US 2026/0111824 A1
(43) Pub. Date: Apr. 23, 2026

(54) SYSTEM AND METHOD FOR AUTOMATED IDENTIFICATION OF CHURNED CLIENTS AND PREDICTIVE ASSESSMENT OF ATTRITION LIKELIHOOD

(71) Applicant: ORACLE INTERNATIONAL CORPORATION, Redwood Shores, CA (US)

(72) Inventors: Karthik Bangalore Mani, Bengaluru (IN); Krishnan Ramanathan, Bengaluru (IN); Vikas Agrawal, Hyderabad (IN); Jagdish Chand, Pleasanton, CA (US)

(21) Appl. No.: 18/918,613

(22) Filed: Oct. 17, 2024

(51) Int. Cl. G06Q 10/0637; G06Q 30/01; G06Q 40/06

(52) U.S. Cl. CPC G06Q 10/0637; G06Q 30/01; G06Q 40/06

(57) ABSTRACT

In accordance with an embodiment, described herein are systems and methods for automated identification of churned client entities (e.g., product purchasers or users, cloud service subscribers, or other types of client entities), generally referred to herein as customers; predictive assessment of customer attrition likelihood; and determination of temporal windows for strategic intervention. The system can be used, for example, to predict if a client (e.g., a customer) will churn; determine a churn timeframe or action window for possible action to address the churn; and/or automatically identify which clients or customers may have already churned. Data or information describing churned clients or customers can be used by the system to automatically determine and/or perform an action directed to particular clients or customers; or can be returned in the form of displayed reports or other data visualizations.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

Embodiments described herein are generally related to data analytics environments, and are particularly directed to systems and methods for automated identification of churned clients (e.g., customers), predictive assessment of customer attrition likelihood, and determination of temporal windows for strategic intervention.

### BACKGROUND

Data analytics are useful in the business-to-business or enterprise ecommerce field to assess customer characteristics and activity. For example, an organization's client or customer churn rate reflects the rate at which its clients or customers are no longer purchasing, subscribing to, or otherwise using a particular product or service. Such information can be useful to the organization in better serving their customers, for example by following-up on customer satisfaction surveys, or offering discounts.

However, presently available systems generally do not provide much in the way of useful information to predict when a particular client or customer might churn; nor provide a means of easily identifying which customers may have potentially already churned.

### SUMMARY

In accordance with an embodiment, described herein are systems and methods for automated identification of churned client entities (e.g., product purchasers or users, cloud service subscribers, or other types of client entities), generally referred to herein as customers; predictive assessment of customer attrition likelihood; and determination of temporal windows for strategic intervention.

The system can be used, for example, to predict if a client (e.g., a customer) will churn; determine a churn timeframe or action window for possible action to address the churn; and/or automatically identify which clients or customers may have already churned.

Data or information describing churned clients or customers can be used by the system to automatically determine and/or perform an action directed to particular clients or customers; or can be returned in the form of displayed reports or other data visualizations.

### BRIEF DESCRIPTION OF THE DRAWINGS

FIG. 1 illustrates an example data analytics system or environment, in accordance with an embodiment.

FIG. 2 further illustrates an example data analytics environment, in accordance with an embodiment.

FIG. 3 further illustrates an example data analytics environment, in accordance with an embodiment.

FIG. 4 further illustrates an example data analytics environment, in accordance with an embodiment.

FIG. 5 further illustrates an example data analytics environment, in accordance with an embodiment.

FIG. 6 further illustrates an example data analytics environment, in accordance with an embodiment.

FIG. 7 illustrates a system for automated identification of churned clients or

customers, in accordance with an embodiment.

FIG. 8 illustrates the use of a customer churn risk and action window, in accordance with various embodiments.

FIG. 9 illustrates a determination of action based on churn risk and customer value, in accordance with an embodiment.

FIG. 10 illustrates a churn label assignment process, in accordance with an embodiment.

FIG. 11 illustrates the use of an empirical cumulative distribution function (eCDF), in accordance with an embodiment.

FIG. 12 illustrates a churn status per customer, in accordance with an embodiment.

FIG. 13 illustrates a model segmentation process, in accordance with an embodiment.

FIG. 14 illustrates a binary classifier and CoxPH process, in accordance with an embodiment.

FIG. 15 further illustrates a binary classifier and CoxPH process, in accordance with an embodiment.

FIG. 16 illustrates an inferencer process, in accordance with an embodiment.

FIG. 17 further illustrates an inferencer process, in accordance with an embodiment.

FIG. 18 illustrates a lookback process, in accordance with an embodiment

FIG. 19 further illustrates a lookback process, in accordance with an embodiment.

FIG. 20 illustrates a calculation of proposed follow-up time (process), in accordance with an embodiment.

FIG. 21 illustrates the use of a system for automated identification of churned clients or customers, in accordance with an embodiment.

FIG. 22 illustrates an example input table, in accordance with an embodiment.

FIG. 23 illustrates an example output table, in accordance with an embodiment.

FIG. 24 further illustrates the use of a system for automated identification of churned clients or customers, in accordance with an embodiment.

### DETAILED DESCRIPTION

Data analytics are useful in the business-to-business or enterprise ecommerce field to assess customer characteristics and activity. For example, an organization's client or customer churn rate reflects the rate at which its clients or customers are no longer purchasing, subscribing to, or otherwise using a particular product or service. Such information can be useful to the organization in better serving their customers, for example by following-up on customer satisfaction surveys, or offering discounts.

However, presently available systems generally do not provide much in the way of useful information to predict when a particular client or customer might churn; nor provide a means of easily identifying which customers may have potentially already churned.

In accordance with an embodiment, described herein are systems and methods for automated identification of churned client entities (e.g., product purchasers or users, cloud service subscribers, or other types of client entities), generally referred to herein as customers; predictive assessment of customer attrition likelihood; and determination of temporal windows for strategic intervention.

In accordance with an embodiment, the system can be used, for example, to predict if a client (e.g., a customer) will churn; determine a churn timeframe or action window for possible action to address the churn; and/or automatically identify which clients or customers may have already churned.

In accordance with an embodiment, data or information describing churned clients or customers can be used by the system to automatically determine and/or perform an action directed to particular clients or customers; or can be returned in the form of displayed reports or other data visualizations.

### Data Analytics Environments

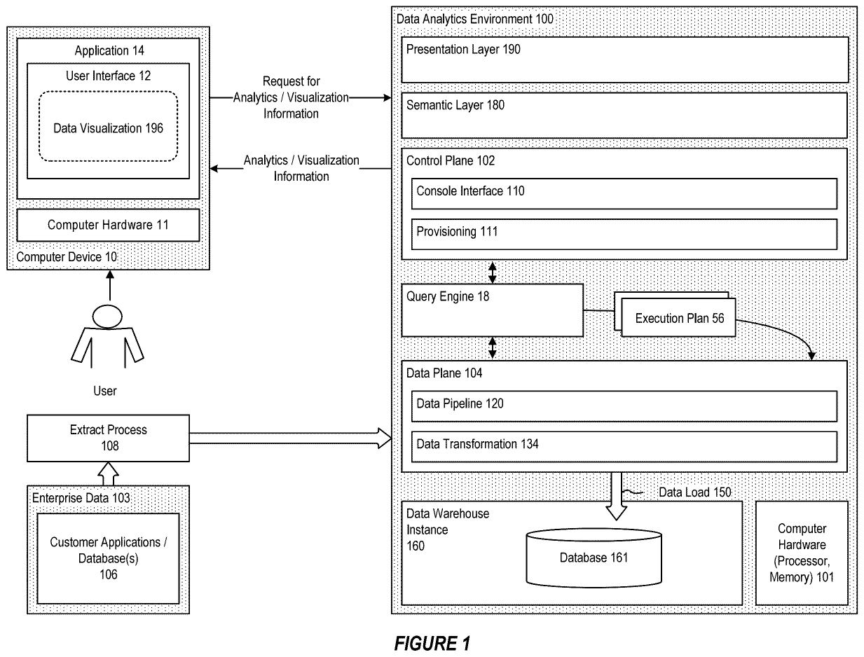

FIG. 1 illustrates an example data analytics environment, in accordance with an embodiment.

The embodiment illustrated in FIG. 1 is provided for illustrating an example data analytics environment in association with which various embodiments described herein can be used. The components and processes illustrated in FIG. 1 and as described elsewhere herein with regard to various other embodiments, can be provided as software or program code executable by, for example, a cloud computing system, or other suitably-programmed computer system.

As illustrated in FIG. 1, in accordance with an embodiment, a data analytics environment 100 can be provided by, or otherwise operate at, a computer system having a computer hardware (e.g., processor, memory) 101, and including one or more software components operating as a control plane 102, and a data plane 104, and providing access in the manner of a data layer 270 to a data warehouse instance 160 (e.g., having a database 161, or other type of data source).

In accordance with an embodiment, the control plane operates to provide control for cloud or other software products offered within the context of a cloud environment. For example, in accordance with an embodiment, the control plane can include a console interface 110 that enables access by a tenant and/or a cloud environment having a provisioning component 111, for example to allow tenants to provision services for use within their enterprise environment. The provisioning component can provision a data warehouse instance, including a customer schema of the data warehouse; and populate the data warehouse instance with the appropriate information supplied by the tenant/customer.

In accordance with an embodiment, the data plane can include a data pipeline or process layer 120 and a data transformation layer 134, that together process data from an organization's enterprise software environment, and load a transformed data into the data warehouse. The data transformation layer can include a data model, such as, for example, a knowledge model (KM), or other type of data model, that the system uses to transform the data received from business applications and corresponding databases, into a model format understood by the data analytics environment. The data plane is responsible for performing extract, transform, and load (ETL) operations, including extracting data from an organization's enterprise software environment, transforming the extracted data into a model format, and loading the transformed data into a customer schema of the data warehouse.

For example, in accordance with an embodiment, each tenant of the environment can be associated with their own customer schema; and can be additionally provided with read-only access to the data analytics schema, which can be updated by a data pipeline or process, for example, an ETL process, on a periodic or other basis. For example, a data pipeline or process can be scheduled to execute at intervals (e.g., hourly/daily/weekly) to extract data from an enterprise software environment, such as, for example, business productivity software applications and corresponding databases 106.

In accordance with an embodiment, an extract process 108 can extract the data, whereupon extraction the data pipeline or process can insert extracted data into a data staging area, which can act as a temporary staging area for the extracted data. When the extract process has completed its extraction, the data transformation layer can be used to transform the extracted data into a model format to be loaded into the customer schema of the data warehouse. During the data transformation, the system can perform dimension generation, fact generation, and aggregate generation, as appropriate. Dimension generation can include generating dimensions or fields for loading into the data warehouse instance.

In accordance with an embodiment, after transformation of the extracted data, the data pipeline or process can execute a warehouse load procedure 150, to load the transformed data into the customer schema of the data warehouse instance. Subsequent to the loading of the transformed data into the customer schema, the transformed data can be analyzed and used in a variety of additional business intelligence processes.

Different tenants may have different requirements with regard to how their data is classified, aggregated, or transformed, for providing data analytics or business intelligence data, or developing software analytic applications. In accordance with an embodiment, to support such different requirements, a semantic layer 180 can include data defining a semantic model of a tenant's data; which is useful in assisting users in understanding and accessing that data using commonly-understood business terms; and provide custom content to a presentation layer 190.

In accordance with an embodiment, a tenant may perform modifications to their data source model, to support their particular requirements, for example by adding custom facts or dimensions associated with the data stored in their data warehouse instance; and the system can extend the semantic model accordingly. A semantic model can be defined, for example, in an Oracle environment, as a BI Repository (RPD) file, having metadata that defines logical schemas, physical schemas, physical-to-logical mappings, aggregate table navigation, and/or other constructs that implement the various physical layer, business model and mapping layer, and presentation layer aspects of the semantic model.

In accordance with an embodiment, the presentation layer can enable access to the data content using, for example, a software analytic application, user interface, analytics dashboard, key performance indicators (KPI's); or other type of report or interface as may be provided by products such as, for example, Oracle Analytics Cloud, or Oracle Analytics for Applications.

In accordance with an embodiment, a query engine 18 (e.g., an Oracle Business Intelligence Server, OBIS instance) operates in the manner of a federated query engine to serve analytical queries or requests from clients directed to data stored at a database. The query engine can push down operations to supported databases, in accordance with a query execution plan 56, wherein a logical query can include Structured Query Language (SQL) statements received from the clients; while a physical query includes database-specific statements that the query engine sends to the database to retrieve data when processing the logical query.

In accordance with an embodiment, a user/developer can interact with a client computer device 10 that includes a computer hardware 11 (e.g., processor, storage, memory), user interface 12, and client application 14. A query engine or business intelligence server generally operates to process inbound, e.g., SQL, requests against a database model, build and execute one or more physical database queries, process the data appropriately, and return the data in response to the request.

To accomplish this, in accordance with an embodiment, the query engine can include a logical or business model, or metadata, that describes the data available as subject areas for queries; a request generator that takes incoming queries and turns them into physical queries for use with a connected data source; and a navigator that takes the incoming query, navigates the logical model and generates those physical queries that best return the data required for a particular query.

For example, in accordance with an embodiment, the query engine may employ a logical model mapped to data in a data warehouse, by creating a simplified star schema business model over various data sources so that the user can query data as if it originated at a single source. The information can then be returned to the presentation layer as subject areas, according to business model layer mapping rules.

In accordance with an embodiment, the query engine can process queries against a database according to a query execution plan. During operation the query engine can create a query execution plan which can then be further optimized, for example to perform aggregations of data necessary to respond to a request. Data can be combined together and further calculations applied, before the results are returned to the calling application.

In accordance with an embodiment, a request for data analytics or visualization information can be received via a client application and user interface as described above, and communicated to the data analytics environment (in the example of a cloud environment, via a cloud service). The system can retrieve an appropriate dataset to address the user/business context, for use in generating and returning the requested data analytics or visualization information to the client, as a data visualization 196.

In accordance with an embodiment, a client application can be implemented as software or computer-readable program code executable by a computer system or processing device, and having a user interface, such as, for example, a software application user interface or a web browser interface. The client application can retrieve or access data via an Internet/HTTP or other type of network connection to the data analytics environment, or in the example of a cloud environment via a cloud service provided by the environment.

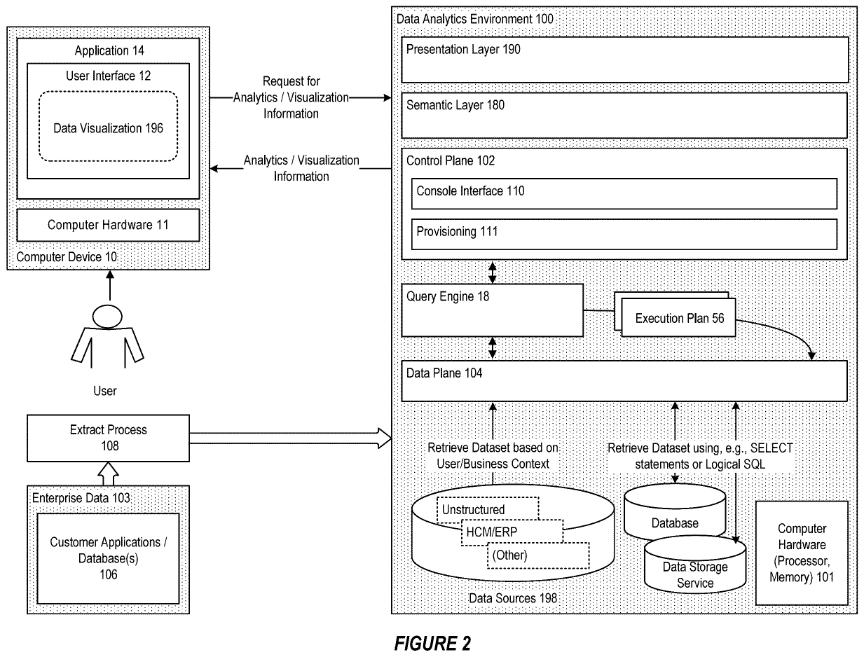

FIG. 2 further illustrates an example data analytics environment, in accordance with an embodiment.

As illustrated in FIG. 2, in accordance with an embodiment, the data analytics environment enables a dataset to be retrieved, received, or prepared from one or more data source(s) 198, for example via one or more data source connections. Examples of the types of data that can be transformed, analyzed, or visualized using the systems and methods described herein include data directed to Enterprise Resource Planning (ERP), Human Capital Management (HCM), or Human Resources (HR), or other types of data provided at one or more of a database, data storage service, or other type of data repository or data source.

For example, in accordance with an embodiment, a request for data analytics or visualization information can be received via a client application and user interface as described above, and communicated to the data analytics environment, for example via a cloud service. The system can retrieve an appropriate dataset to address the user/business context, for use in generating and returning the requested data analytics or visualization information to the client.

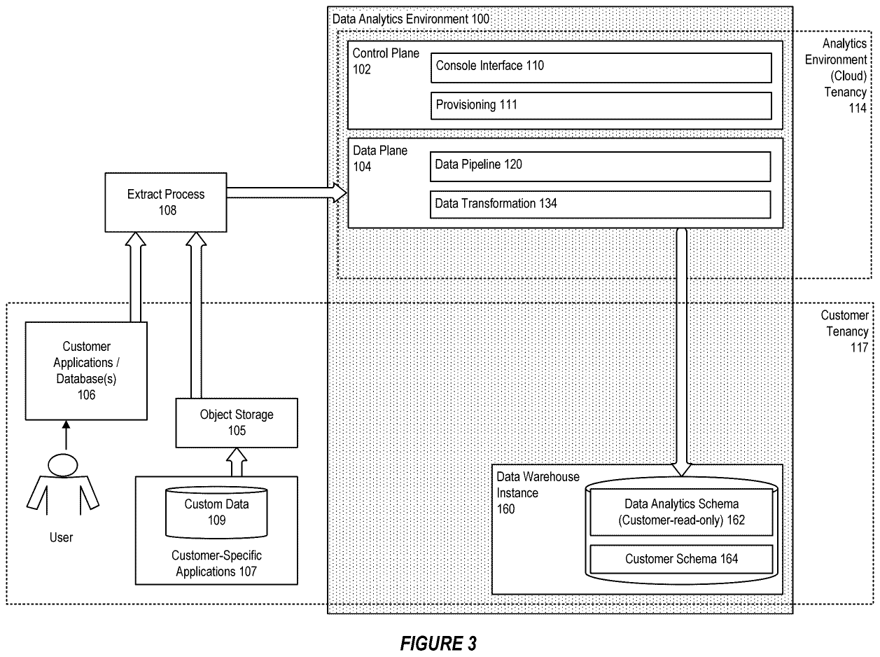

FIG. 3 further illustrates an example data analytics environment, in accordance with an embodiment.

As illustrated in FIG. 3, in accordance with an embodiment, data can be sourced, e.g., from a tenant's enterprise software environment (106), using the data pipeline process; or as custom data 109 sourced from one or more tenant or customer-specific applications 107; and loaded to a data warehouse instance, including in some examples the use of an object storage 105 for storage of the data. A user can create a dataset that uses tables from different connections and schemas. The system uses the relationships defined between these tables to create relationships or joins in the dataset.

In accordance with an embodiment, the data warehouse can include a default data analytics schema 162 and, for each tenant of the system, a customer schema 164. For each tenant, the system uses the data analytics schema that is maintained and updated by the system, within a system/cloud tenancy 114, to pre-populate a data warehouse instance for the tenant, based on an analysis of the data within that tenant's enterprise applications environment, and within a customer tenancy 117. As such, the data analytics schema maintained by the system enables data to be retrieved, by the data pipeline or process, from the tenant's environment, and loaded to the tenant's data warehouse instance.

In accordance with an embodiment, the system also provides, for each tenant of the environment, a customer schema that allows the tenant to supplement and utilize the data within their own data warehouse instance. For each tenant, their resultant data warehouse instance operates as a database whose contents are partly-controlled by the tenant; and partly-controlled by the environment (system).

For example, in accordance with an embodiment, a data warehouse can include a data analytics schema and, for each tenant, a customer schema sourced from their enterprise software environment. The data provisioned in a data warehouse tenancy is accessible only to that tenant; while at the same time allowing access to various, e.g., ETL-related or other features of the shared environment.

In accordance with an embodiment, for a particular tenant, upon extraction of their data, the data pipeline or process can insert the extracted data into a data staging area for the tenant, which can act as a temporary staging area for the extracted data. When the extract process has completed its extraction, the data transformation layer can be used to transform the extracted data into a model format to be loaded into the customer schema of the data warehouse.

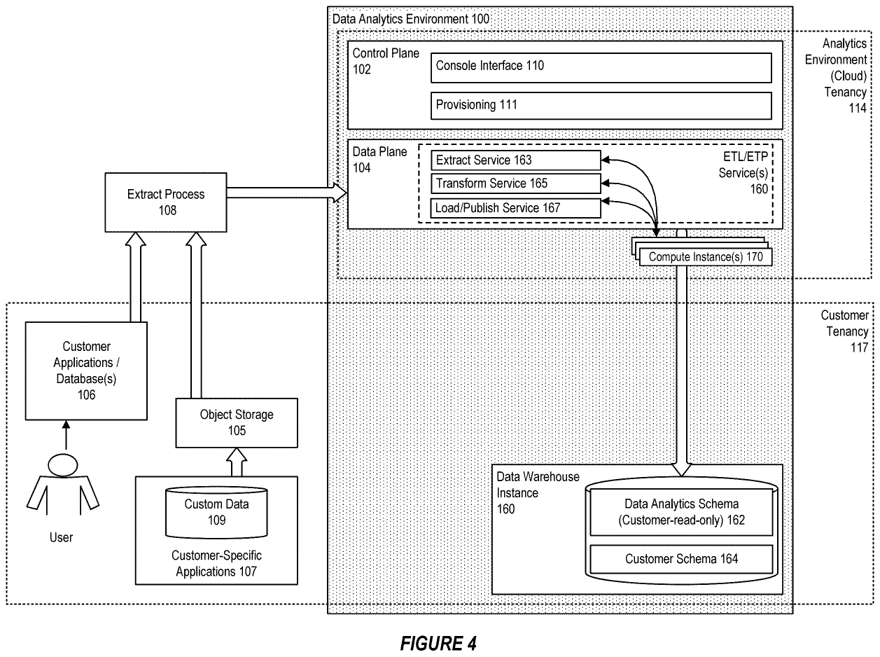

FIG. 4 further illustrates an example data analytics environment, in accordance with an embodiment.

As illustrated in FIG. 4, in accordance with an embodiment, the process of extracting data from a tenant's enterprise software environment, and loading the data to a data warehouse instance, or refreshing the data in a data warehouse, generally involves several stages, performed by an ETP service 160 or process, including one or more extraction service 163; transformation service 165; and load/publish service 167, executed by one or more compute instance(s) 170.

For example, in accordance with an embodiment, extracted files can be uploaded to an object storage component for storage of the data. The transformation process then applies a business logic while loading them to a target data warehouse, e.g., an Autonomous Data Warehouse (ADW) database, which is internal to the data pipeline or process, and is not exposed to the tenant. A load/publish service or process takes the data from the ADW database and publishes it to a data warehouse instance that is accessible to the tenant.

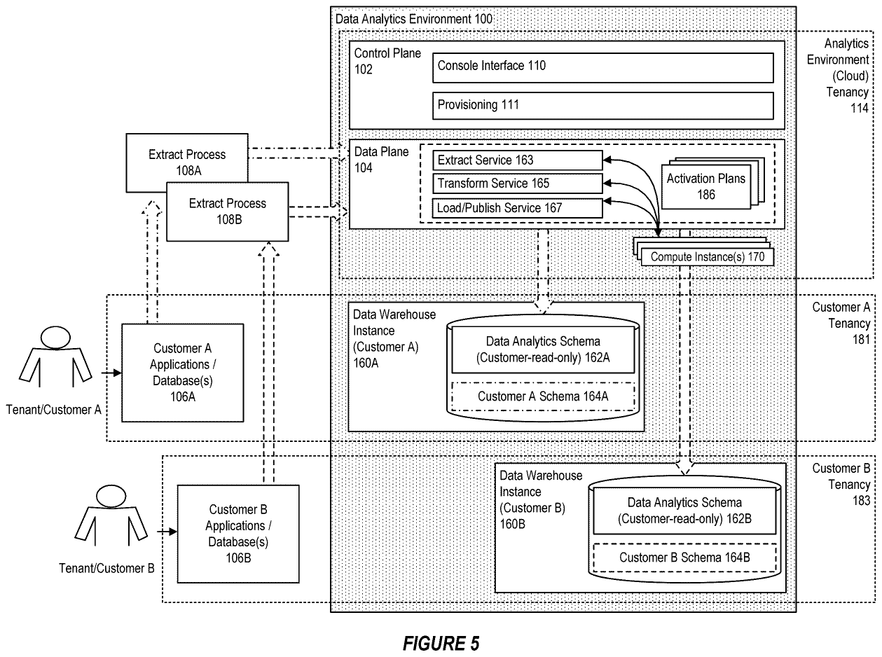

FIG. 5 further illustrates an example data analytics environment, in accordance with an embodiment.

As illustrated in FIG. 5, in accordance with an embodiment, the data pipeline or process maintains, for each of a plurality of tenants, for example Customer A 180, Customer B 182, a data analytics schema that is updated on a periodic basis, by the system in accordance with best practices for a particular analytics use case. For each of a plurality of tenants (e.g., Customers A, B), the system uses the data analytics schema 162A, 162B, that is maintained and updated by the system, to pre-populate a data warehouse instance for the tenant, based on an analysis of the data within that tenant's enterprise applications environment 106A, 106B, and within each customer's tenancy (e.g., Customer A tenancy 181, Customer B tenancy 183); so that data is retrieved, by the data pipeline or process, from the tenant's environment, and loaded to the tenant's data warehouse instance 160A, 160B.

In accordance with an embodiment, the data analytics environment also provides, for each of a plurality of tenants of the environment, a customer schema (e.g., Customer A schema 164A, Customer B schema 164B) that allows the customer to supplement and utilize the data within their own data warehouse instance.

As described above, in accordance with an embodiment, for each of a plurality of tenants of the data analytics environment, their resultant data warehouse instance operates as a database whose contents are partly-controlled by the tenant; and partly-controlled by the data analytics environment (system); including that their database appears pre-populated with appropriate data that has been retrieved from their enterprise applications environment to address various analytics use cases. When the extract process 108A, 108B for a particular tenant has completed its extraction, the data transformation layer can be used to transform the extracted data into a model format to be loaded into the customer schema of the data warehouse.

In accordance with an embodiment, activation plans 186 can be used to control the operation of the data pipeline or process services for a tenant, for a particular functional area, to address that tenant's particular needs. For example, an activation plan can define a number of extract, transform, and load (publish) services or steps to be run in a certain order, at a certain time of day, and within a certain window of time.

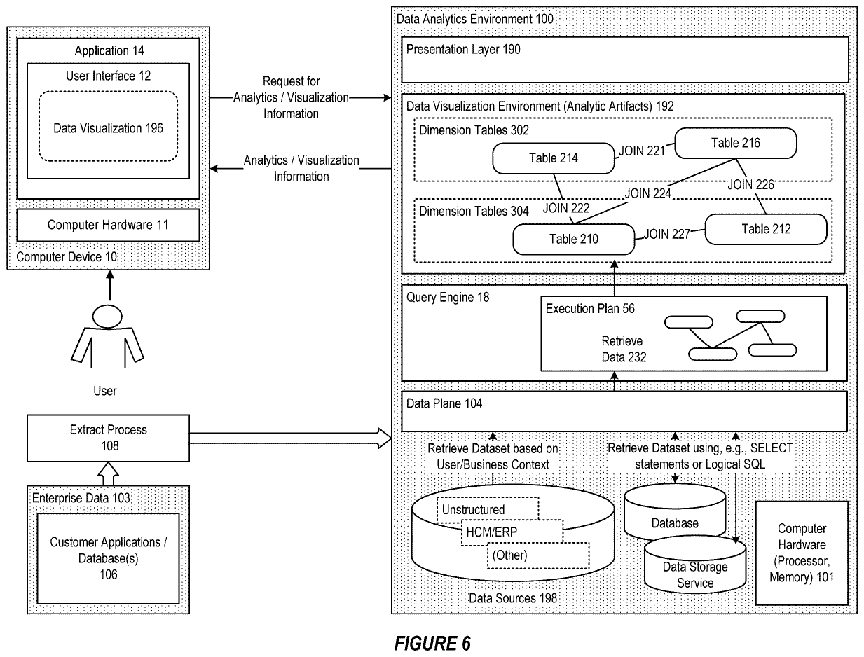

FIG. 6 further illustrates an example data analytics environment, in accordance with an embodiment.

Generally described, within a database or data warehouse, the data of interest may be spread across multiple tables. In such environments, joins can be used to stitch the data from various tables together, to better prepare the data for analysis.

For example, as illustrated in FIG. 6, in accordance with an embodiment, the data analytics environment enables a dataset to be retrieved, received, or prepared from one or more data source(s), for example via one or more data source connections, fact and/or dimension tables 210-216, or joins 221-227 between selections of dimension tables 302, 304.

In accordance with an embodiment, a request received at a data visualization environment to display analytic artifacts 192, for example as may be related to key performance indicators, analytics dashboards, or scorecards, can be received via a client application and user interface as described above, and communicated to the data analytics environment via a cloud service. The system can retrieve 232 an appropriate dataset using, e.g., SELECT statements, to address the user/business context, for use in generating and returning the requested data analytics or visualization information to the client.

### Automated Identification of Churned Clients (Customers)

Data analytics are useful in the business-to-business or enterprise ecommerce field to assess customer characteristics and activity. For example, an organization's client or customer churn rate reflects the rate at which its clients or customers are no longer purchasing, subscribing to, or otherwise using a particular product or service. Such information can be useful to the organization in better serving their customers, for example by following-up on customer satisfaction surveys, or offering discounts.

However, presently available systems generally do not provide much in the way of useful information to predict when a particular client or customer might churn; nor provide a means of easily identifying which customers may have potentially already churned.

In accordance with an embodiment, described herein are systems and methods for automated identification of churned client entities (e.g., product purchasers or users, cloud service subscribers, or other types of client entities), generally referred to herein as customers; predictive assessment of customer attrition likelihood; and determination of temporal windows for strategic intervention.

In accordance with an embodiment, the system can be used, for example, to predict if a client (e.g., a customer) will churn; determine a churn timeframe or action window for possible action to address the churn; and/or automatically identify which clients or customers may have already churned.

In accordance with an embodiment, data or information describing churned clients or customers can be used by the system to automatically determine and/or perform an action directed to particular clients or customers; or can be returned in the form of displayed reports or other data visualizations.

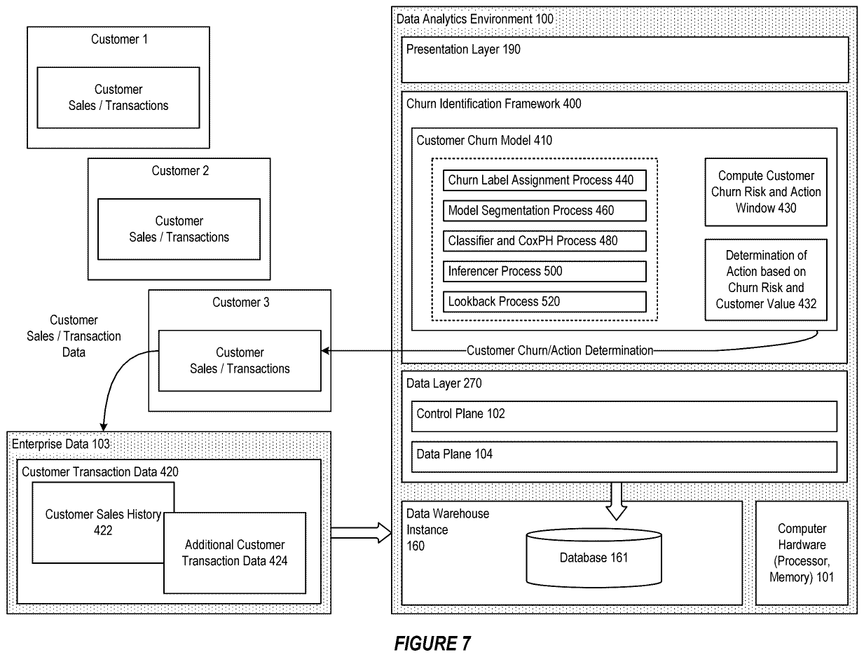

FIG. 7 illustrates a system for automated identification of churned clients or customers, in accordance with an embodiment.

As described above, an organization may be interested in assessing which clients or customers are no longer purchasing, subscribing to, or otherwise using a particular product or service, for use by the organization in better servicing its customers.

For example, the organization may wish to identify if a particular customer is likely to churn, based on a risk score, and determine an appropriate follow-up action, such as offering that customer a discount on the corresponding product or service. If the system determines that a particular customer has a high risk score, and also has a high customer value; but that there is a small action window available; then this may indicate a need to act aggressively to retain that customer.

As illustrated in FIG. 7, and further described below, in accordance with an embodiment, the system can include a churn identification framework 400, which maintains a customer churn (data) model 410, and is operated upon by one or more churn label assignment process 440, model segmentation process 460, binary classifier and CoxPH process 480, inferencer process 500, and lookback process 520.

In accordance with an embodiment, the system can receive as enterprise data a customer transaction data 420, including, for example, a customer sales history 422 and/or additional customer transaction data 424 associated with a plurality of client entities (e.g., product purchasers or users, cloud service subscribers, or other types of client entities), generally referred to herein as customers, for example Customer 1, Customer 2, and Customer 3.

In accordance with an embodiment, the system can apply the customer churn model and associated processes, to the received customer transaction data, to compute a customer churn risk and action window (430), and determine an action based on the churn risk and customer value (432).

The customer churn/action determination can then be utilized in determining a follow-up action, for example, to aggressively retain, divest, grow, or maintain the customer, as appropriate for the organization's needs or to address its business goals.

Generally described, in accordance with an embodiment, the application of the customer churn model and associated processes, to the received customer transaction data, includes:
1. The automatic determination of which clients or customers appear to have churned, for example using an empirical cumulative distribution function (eCDF).
2. The automatic determination of soft churn rather than hard churn, based on an assessment of a customer's direct monetary influence or spend, to take into account each customer's overall size of orders or value amounts.
3. Model segmentation based on customer segmentation, and identification of multipliers per customer/model segment for churn cut-off days.
4. The determination by the system of a classification and action window or time period available for possible intervention for churned customers.
5. A means of making the classification and determination of time period available to be consistent.
6. The use of a model deployment decider to periodically determine when the customer churn (data) model should be deployed or updated.
   I. Auto Churn Labeling (eCDF-Based)

As described above, in accordance with an embodiment, the system can receive as enterprise data a customer transaction data, including, for example, a customer sales history and/or additional customer transaction data associated with a plurality of customers, and apply the customer churn model and associated processes, to the received customer transaction data, to compute a customer churn risk and action window, and determine an action based on the churn risk and customer value.

In accordance with an embodiment, the system assesses the 90th percentile of a customer's transactions to determine the churn cut-off days associated with the customer. This provides a more objective criterion as to whether the customer is still active, or alternatively may have already churned.

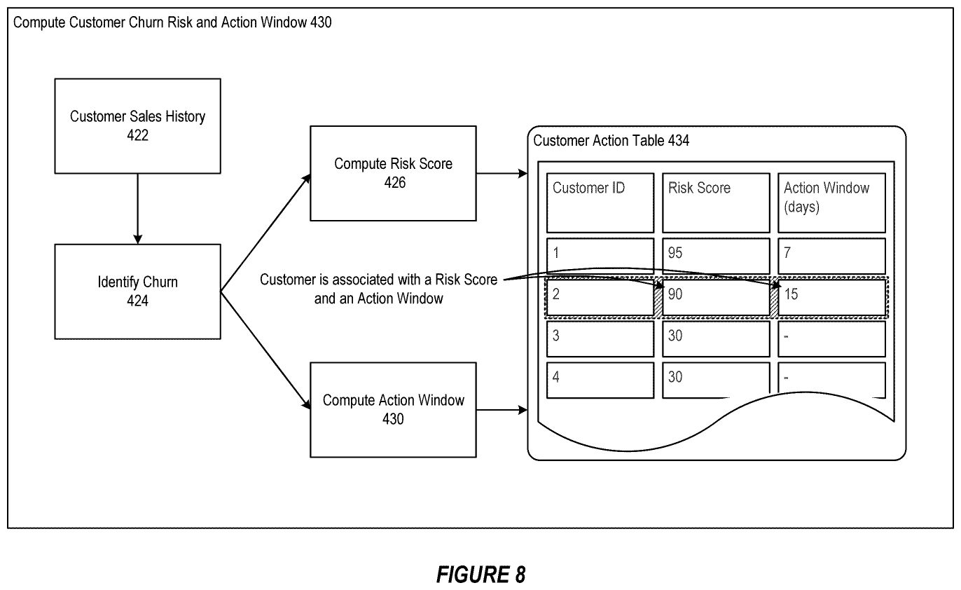

FIG. 8 illustrates the use of a customer churn risk and action window, in accordance with various embodiments.

As illustrated in FIG. 8, in accordance with an embodiment, based on the assessment of the customer sales history, the system can operate to identify potential churn associated with a customer (424), and compute a risk score (426) and action window (430).

In accordance with an embodiment, each particular customer can then be associated with a risk score and action window, provided within a customer action table 434.

For example, a first customer (Customer ID=1) may be associated with a risk score of 95, and an action window of 7 days; while a second customer (Customer ID=2) may be associated with a risk score of 90, and an action window of 15 days. Similarly, additional customers (Customer ID=3; ID=4) may be associated with, respectively, risk scores of 30, and other action windows or time periods available for possible intervention.

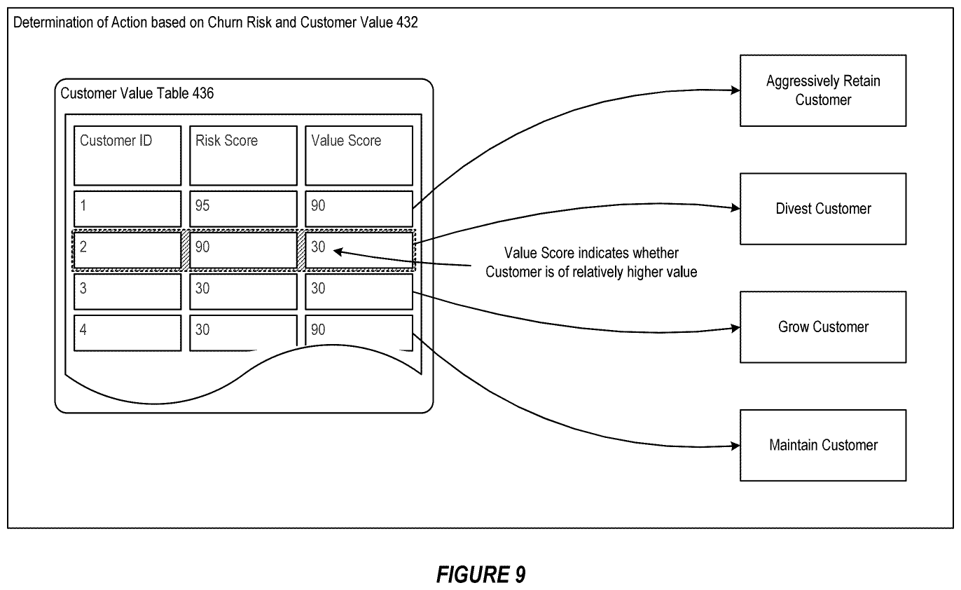

FIG. 9 illustrates a determination of action based on churn risk and customer value, in accordance with an embodiment.

As illustrated in FIG. 9, if, for example, the system determines that a particular customer (e.g. Customer ID=1) has a high risk score, and also has a high customer value score, as indicated by its information provided within a customer value table 436; but that there is a small action window available; then this may indicate a need to act aggressively to retain that particular customer, and the system can automatically determine and/or perform such action.

For other customers, based on their risk score, value score, and action window, the system may respond differently, to automatically determine and/or perform a different action, for example to divest, grow, or maintain the customer, as appropriate for the organization's needs or to address its business goals.

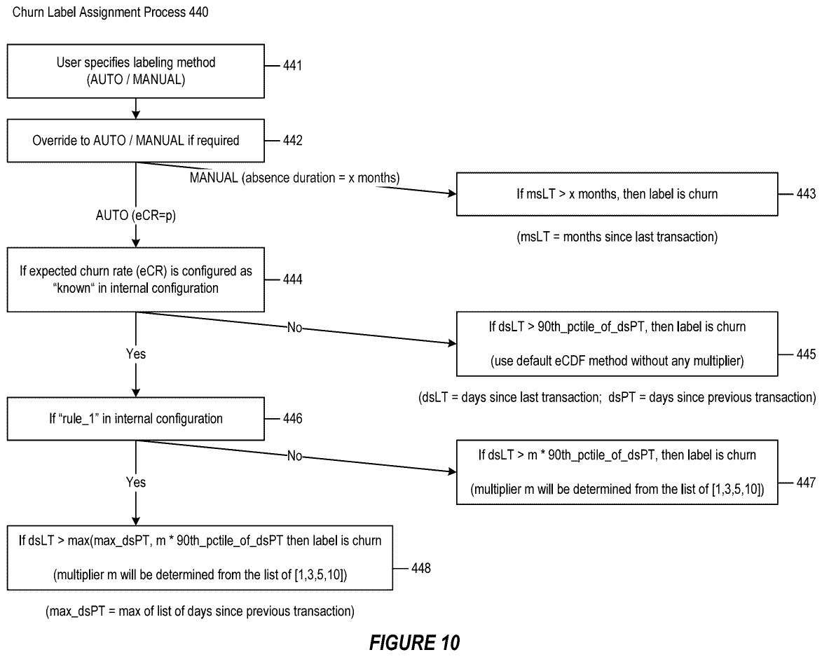

FIG. 10 illustrates a churn label assignment process, in accordance with an embodiment.

In accordance with an embodiment, the system can operate to automatically identify or label a customer as churned (label=CHURN), or allow a user to assign a churn label manually.

In accordance with an embodiment, the user can input a percentage value used to determine the churn cut-off days; and the system can determine the best multiplication factor (m) per customer/model segment from a configurable list, for example: 1, 3, 5, 10.

In accordance with an embodiment, the process generally recognizes:
CHURN_CUT_OFF_DAYS: 90th percentile of time gaps between successive purchase transactions by a customer

For example, the system can: record a list of the number of days between each successive transaction; sort the list (by number of days) in ascending order; and find the 90th percentile of the list, to provide a value for CHURN_CUT_OFF_DAYS.

In accordance with an embodiment, the process then operates wherein:
If DAYS_SINCE_LAST_TXN>CHURN_CUT_OFF_DAYS: Customer has churned

For example, in accordance with an embodiment, the system can identify the amount of days that have passed since a particular customer has made their last transaction (DAYS_SINCE_LAST_TXN).

If DAYS_SINCE_LAST_TXN>Max (max (DAYS_SINCE_PREV_TXN), m*90th percentile) then the system can assign to the customer a label CHURN, else the label is assigned as NOT_CHURNED.

In accordance with an embodiment, an alternative MANUAL method can be used, for example if the customer has not made any transactions in the past N months, in which case the label can be manually assigned as CHURN.

As illustrated in FIG. 10, in accordance with an embodiment, the churn label assignment process comprises, at step 441, receiving an indication as to the labeling method (e.g., AUTO, or MANUAL).

At step 442, the process can override the label assignment process to operate as MANUAL if desired, and then, at step 443, determine whether a value for mSLT (months since last transaction) is greater than x months, in which case the customer is labeled as churned.

If at step 444, the expected churn rate (eCR) process is not configured as “known” in an internal configuration, then, at step 445, a determination is made:
If dsLT>90th_pctile_of_dsPT

In which case the label is assigned CHURN (using the default eCDF method without any multiplier; where dsLT=days since last transaction; and dsPT=days since previous transaction).

Alternatively, at step 444, if the eCR is configured as “known” in the internal configuration, then at steps 446, 447:
If dsLT>m*90th_pctile_of_dsPT

Then the label is assigned CHURN (where the multiplier m will be determined from the list of [1,3,5,10]). Alternatively, at step 448:
If dsLT>max (max_dsPT, m*90th_pctile_of_dsPT

Then the label is assigned CHURN (where the multiplier m will be determined from the list of [1,3,5,10]), wherein max_dsPT=max of list of days since previous transaction.

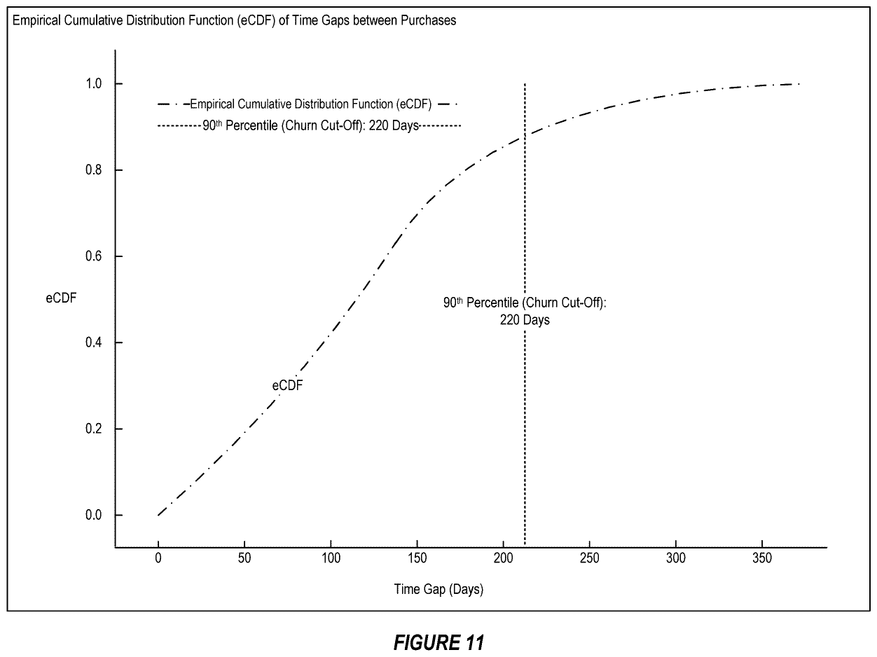

FIG. 11 illustrates the use of an empirical cumulative distribution function (eCDF), in accordance with an embodiment.

As illustrated in FIG. 11, in accordance with an embodiment, the chart shown therein illustrates that for a particular customer, the churn cut-off at 90th percentile is 220 days. In this example, if the last transaction for the customer is greater than 220 days, then the system will label the customer as churned.

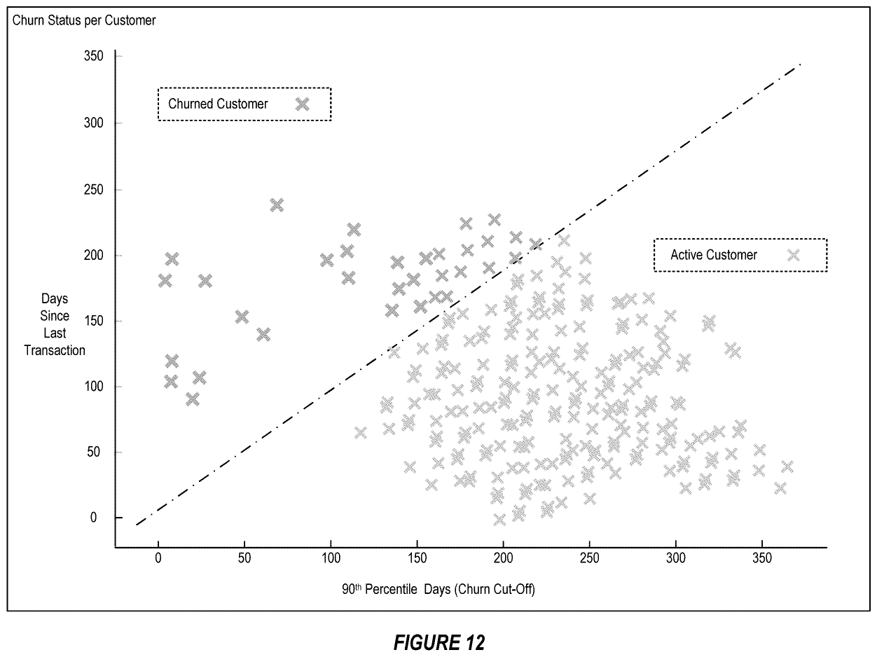

FIG. 12 illustrates a churn status per customer, in accordance with an embodiment.

As illustrated in FIG. 12, in accordance with an embodiment, the chart shown therein illustrates that for a plurality of customers, based on their churn cut-off data at the 90th percentile, a number of customers have churned, while others remain active.

### II. Determination of Soft Churn

As described above, in accordance with an embodiment, the system can apply the customer churn model and associated processes to received customer transaction data, to compute a customer churn risk and action window, and determine an action based on the churn risk and customer value.

In accordance with an embodiment, the system can be further extended to take into account each customer's overall size of orders or value amounts.

To accomplish this, the system can operate to extract a profile (e.g., a feature vector) for each customer, which takes into account or considers its transaction history until a present (or otherwise-specified) date. This ensures the latest transaction data is used for training the model. The plurality of customers are segmented into large, mid-size, or small segments based on their overall spend. The system can perform a random split of customers (e.g., 80:20) per segment for training/testing; and then use the resultant model to score all possible customers.

In accordance with an embodiment, the model operates to segment the customers into large, mid-size, or small customers based on their overall revenues received, rather than on their individual transactions. The system can then train and execute the model in a manner that is more appropriate to each customer type, to better assess a probability a particular customer may churn. The described approach enables variations of the model or algorithm to be tuned for the different sizes of customers, to provide accurate information for a wide variety of customer types, with little noise.

In accordance with an embodiment, the process comprises:

### Soft Churn Determination-Part 1:

For each customer, add new features (assuming total spend and total amount of transactions exists) to the classification model, including those based on overall number of transactions.

For all customers, classify a customer as churned if their recent spending rate is below 25% of their base spending rate (referred to herein as a golden classification), then:

$$MONTHS\_FOR \_ 90 PCT\_AMOUNT = the number of months the customer takes from their first transtion to make 90 \% of the total monetary amount of transactions until the present ( or otherwise - specified ) date . This factor is preferable , since it indicates the overall size of the {customer}^{′} s business . \qquad 1 A .$$

$$MONTHS\_FOR \_ 90 PCT\_COUNT = the number of months the customer takes to make 90 \% of the number of transactions ( not preferable ) . \qquad 1 B .$$

$$MONTHS\_FOR \_REM \_ 10 PCT\_AMOUNT = the number of months the customer takes to make the remaining 10 \% of the amount in transactions from the end of the 90 \% set counting until the present ( or otherwise - specified ) date . The extent to which this period is large or small can be used in determining whether the customer churned or not . \qquad 2.$$

$$Base Spending Rate = \begin{matrix}90 \% of Total Spend / \\ MONTHS\_FOR \_ 90 PCT\_AMOUNT .\end{matrix} \qquad 3.$$

$$Recent Spending Rate = \begin{matrix}10 \% of Total Spend / \\ MONTHS\_FOR \_REM \_ 10 PCT\_AMOUNT .\end{matrix} \qquad 4.$$

$$Base Transaction Rate = \begin{matrix}90 \% of Total Amount of Transactions / \\ MONTHS\_FOR \_ 90 PCT\_COUNT .\end{matrix} \qquad 5.$$

$$Recent Spending Rate = \begin{matrix}10 \% of Total Amount of Transactions / \\ MONTHS\_FOR \_ 10 PCT\_COUNT .\end{matrix} \qquad 6.$$

### Soft Churn Determination-Part 2:

Perform training and random split on customers:

Training: use the golden classification to train the model on all customers using a random 80:20 split, ensuring an 80:20 split on each segment.

Scoring: at scoring time use the feature set as of the present (or otherwise-specified) date to assign a customer a probability score for churn.

Metrics: for metrics, compare with the golden classification as of the present (or otherwise-specified) date.

### Example 1: Large Customer by Amount

Determine the duration (MONTHS_FOR_90PCT_AMOUNT) the customer takes to make 90% of the monetary amount of transactions.

Total spend by customer is $100,000.

Let us consider $90,000 was spent over 5 years.

The spend rate in this 90% period is $1500/month.

The time clock for counting the 10% transactions starts when the last of 90% transactions was performed, and goes until the present (or otherwise-specified) date. 10% of transactions were performed in 1 month (i.e., the time clock starts when the 90% transaction was performed and goes until sysdate). Recent rate of spending=$10,000/1 month=$10000/month. 10% of transactions were in 6 months. Recent rate of spending=$10,000/6 months=$1450/month. 10% of transaction were performed in 25 months. Recent rate of spending=$10,000/25 months=$400/month.

In the above example, the system determines this may be a churn case.

### Example 2: Mid-Size Customer by Transactions

Determine the duration (MONTHS_FOR_90PCT_COUNT) the customer takes to make 90% of their amount of transactions.

Total amount of transactions by customer is 1000.

Let us consider 900 transactions were performed over 5 years.

Transactions rate in this 90% period is 900/60=15/month.

There is a time period after the last of the 90% transactions is performed. 10% of transactions were made in 1 month. Recent rate of transactions=100/1 month=100/month. 10% of transactions were in 6 months. Recent rate of transactions=100/6 months=16.6/month. 10% of transaction were performed in 25 months. Recent rate of transactions=100/25 months=4/month.

In the above example, the system determines this may be a churn case.

### Example 3: Small Customer by Transactions

Determine the duration (MONTHS_FOR_90PCT_COUNT) the customer takes to make 90% of their amount of transactions.

Total amount of transactions by customer is 100.

Let us consider 90 transactions were performed over 5 years.

The spend Rate in this 90% period is 90/60=1.5/month. There is a time period after the last of the 90% transactions is performed. 10% of transactions were made in 1 month. Recent rate of transactions=10/1 month=10/month. 10% of transactions were in 6 months. Recent rate of transactions=10/6 months=1.66/month. 10% of transaction were performed in 25 months. Recent rate of transactions=10/25 months=0.4/month.

In the above example, the system determines this may be a churn case.

### III: Model Segmentation Based on Customer Size

As described above, in accordance with an embodiment, the system can be further extended to take into account each customer's overall size of orders or value amounts, for example to segment the customers, into large, mid-size, or small customers based on their overall revenues received.

In accordance with an embodiment, a multiplication factor can be used to provide a better fit for some customers. For example, in order to train the model accordingly, the system can assess various parameters associated with a customer, find the best multiplier for the customer; and then calculate or fit the model.

In accordance with an embodiment, model segmentation includes:

### Model Segmentation—Part 1:

In accordance with an embodiment, part 1 of the process includes segmenting the data; for example the create three segments, and add a feature column that indicates to which segment the customer belongs, and the train one model which includes the above features, where, for example:

Large customers: total spend >90th percentile over all customers.

Mid-size customers: total spend between 11th to 89th percentile or amount of total transactions is between 11th to 89th percentile.

Small customer: total spend below 10th percentile or amount of total transactions is below 10th percentile.

In accordance with an embodiment, the system can determine the size of this multiplier statistically by using the distribution, for example by finding the median days between transactions and adding to it 4× or 6× standard deviation of the days between transactions. This can also be used to determine the CHURN_CUT_OFF_DAYS, or golden classification.

### Model Segmentation-Part 2:

In accordance with an embodiment, the model takes into account the features: DAYS_SINCE_LAST_TXN/Max (max (DAYS_SINCE_PREV_TXN), m*90th pcttile). This feature can be added this only after determining “m”, the multiplier.

Perform training and random split on customers: use this golden classification to train the model on all customers using a random 80:20 split ensuring an 80:20 split on each segment.

Scoring: Score only the customers with the criteria DAYS_SINCE_LAST_TXN<Max (max (DAYS_SINCE_PREV_TXN), m*90th pcttile). For the other customers, fill in the prediction as churn. At scoring time, the system uses the feature set as of the present (or otherwise-specified) date to assign a customer a probability score for churn.

In accordance with an embodiment, the system can provide a spend_segment column for prediction table; and add the total spend amount spent so far per customer. We have already segmented the customers based on their purchase counts (column_name: PURCH_FREQ_BUCKET).

Metrics: For metrics, compare with the golden classification as of date per segment.

### Segmentation Part 3:

In accordance with an embodiment, the system can identify multipliers per segment for churn. The various parameters that can be considered include:

eCDF_threshold: days_since_prev_txn corresponding to this percentile
is the churn_cut_off_days.
txn_days: choose only such customers who made transactions on at least
x days.
tenure_in_months: choose customers with a certain minimum tenure.
date_timeframe: chose these many months of data for the app.
multiplication_factor: if days_since_last_txn > multiplication_factor *
churn_cut_off_days then label as churn.

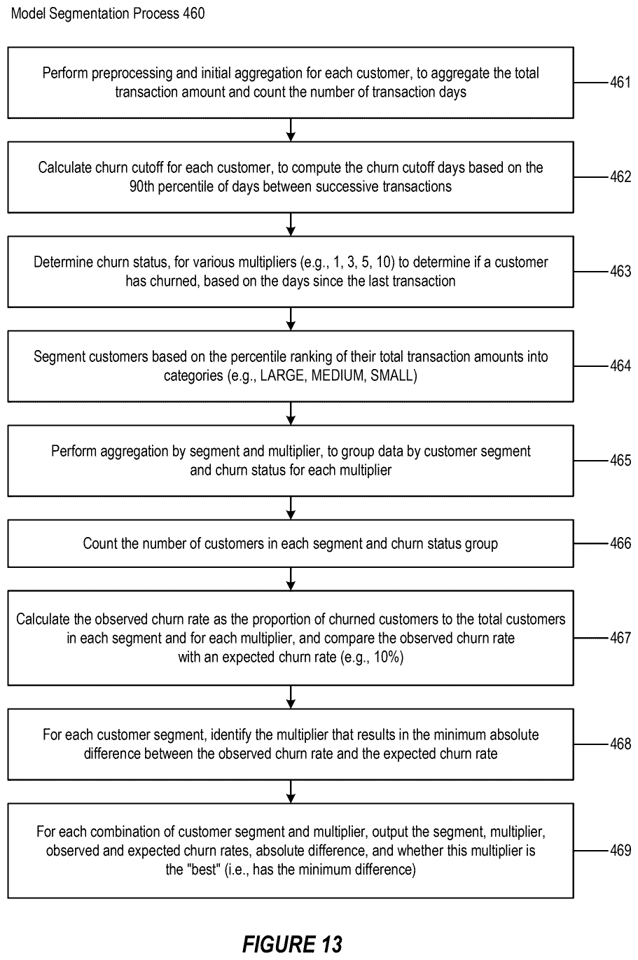

FIG. 13 illustrates a model segmentation process, in accordance with an embodiment.

As illustrated in FIG. 13, in accordance with an embodiment, the process can include, at step 461, performing preprocessing and initial aggregation for each customer, to aggregate the total transaction amount and count the number of transaction days.

For example, in accordance with an embodiment, the system can determine the following for each customer: foreignamount_total: total amount of transactions; and txn_days: number of distinct transaction days.

At step 462, the system can calculate churn cut-off for each customer, to compute the churn cut-off days based on the 90th percentile of days between successive transactions.

At step 463, the system can determine churn status, for various multipliers (e.g., 1, 3, 5, 10) to determine if a customer has churned, based on the days since the last transaction, for example exceed the maximum of the multiplier times the churn cut-off days or a preset maximum days since the last transaction.

At step 464, the system can segment customers based on the percentile ranking of their total transaction amounts into categories (e.g., LARGE, MID-SIZE, SMALL).

At step 465, the system performs aggregation by segment and multiplier, to group data by customer segment and churn status for each multiplier.

At step 466, the system counts the number of customers in each segment and churn status group.

At step 467, the system calculates the observed churn rate as the proportion of churned customers to the total customers in each segment and for each multiplier, and compare the observed churn rate with an expected churn rate (e.g., 10%).

At step 468, for each customer segment, the system can identify the multiplier that results in the minimum absolute difference between the observed churn rate and the expected churn rate.

At step 469, for each combination of customer segment and multiplier, the process outputs the segment, multiplier, observed and expected churn rates, absolute difference, and whether this multiplier is the “best” (i.e., has the minimum difference).

### IV. Classification and CoxPH Action Window

As described above, in accordance with an embodiment, the system can apply the customer churn model and associated processes, to the received customer transaction data, to compute a customer churn risk and action window, and determine an action based on the churn risk and customer value.

In accordance with an embodiment, the system can use a CoxPH algorithm or process to predict a time period within which there is a potential to retain a particular customer, and based on this determine an action window for that customer. Classification can be based on the use of gradient boosted trees (GBT), with survival analysis based on the CoxPH process.

In accordance with an embodiment, training includes extracting features; extracting target labels via eCDF; training a binary classifier to predict churn/non-churn; and training a CoxPH model to predict an action window.

In accordance with an embodiment, scoring includes extracting features; predicting a churn/non-churn label via the binary classifier; predicting an action window via CoxPH; and training and predicting tenure probabilities via a Kaplan-Meier estimator or other process.

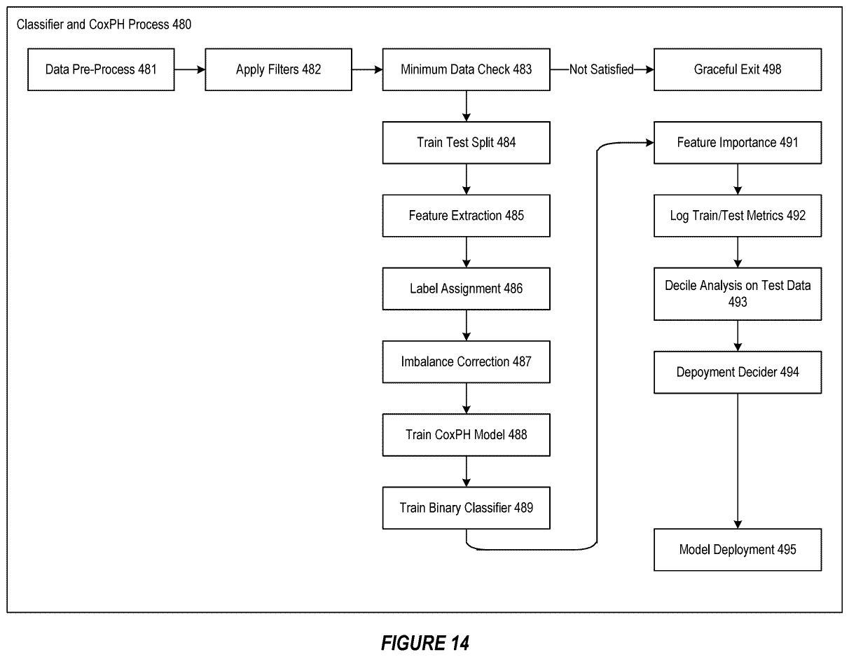

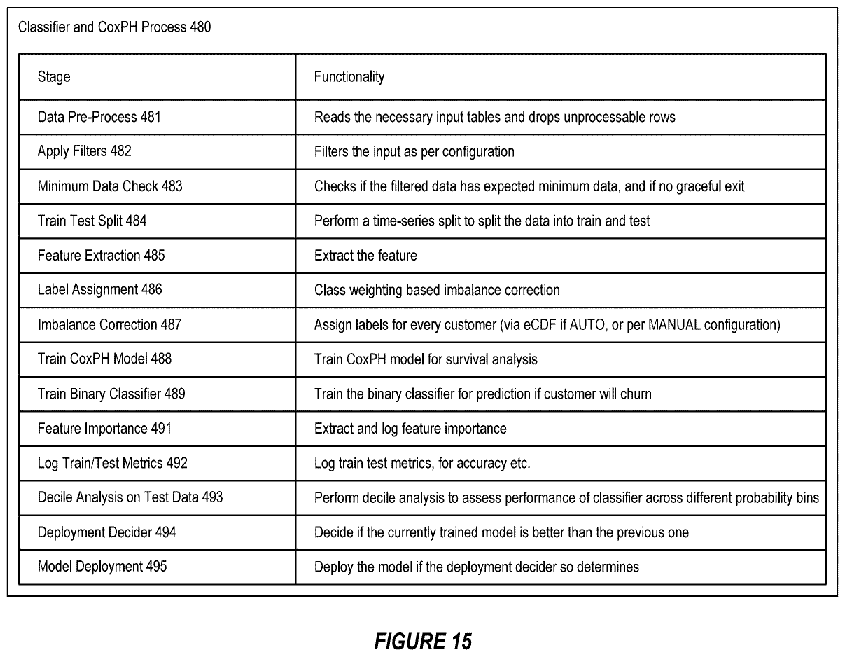

FIGS. 14-15 illustrate a binary classifier and CoxPH process, in accordance with an embodiment. As illustrated in FIGS. 14-15, in accordance with an embodiment, the binary classifier and CoxPH process can include various stages and associated steps, comprising:

A data pre-process stage (481) wherein the system operates to read the necessary input tables and drop unprocessable rows.

An apply filters stage (482) wherein the system operates to filter the input as per configuration.

A minimum data check stage (483) wherein the system operates to check if the filtered data has expected minimum data, and if not then results in a graceful exit (498).

A train test split stage (484) wherein the system operates to perform a time-series split to split the data into train and test datasets.

A feature extraction stage (485) wherein the system operates to extract the features.

A label assignment stage (486) wherein the system operates to class weighting based imbalance correction.

An imbalance correction stage (487) wherein the system operates to assign labels for every customer via an eCDF or MANUAL method (depending on configuration).

A train CoxPH model stage (488) wherein the system operates to train the CoxPH model for survival analysis.

A train binary classifier (489) wherein the system operates to train the binary classifier for prediction if a customer will churn.

A feature importance stage (491) wherein the system operates to extract and log feature importance.

A log train/test metrics stage (492) wherein the system operates to log train test metrics, for accuracy etc.

A decile analysis on test data stage (493) wherein the system operates to perform a decile analysis to assess the performance of the binary classifier across different probability bins.

A deployment decider stage (494) wherein the system operates to decide if the currently trained model is better than the previous one.

A model deployment stage (495) wherein the system operates to deploy the model if the decider so determines.

The above are provided by way of example; in accordance with an embodiment the binary classifier and CoxPH process can include additional and/or different stages that perform additional or other functionalities.

In accordance with an embodiment survival time prediction can be based on an inference process.

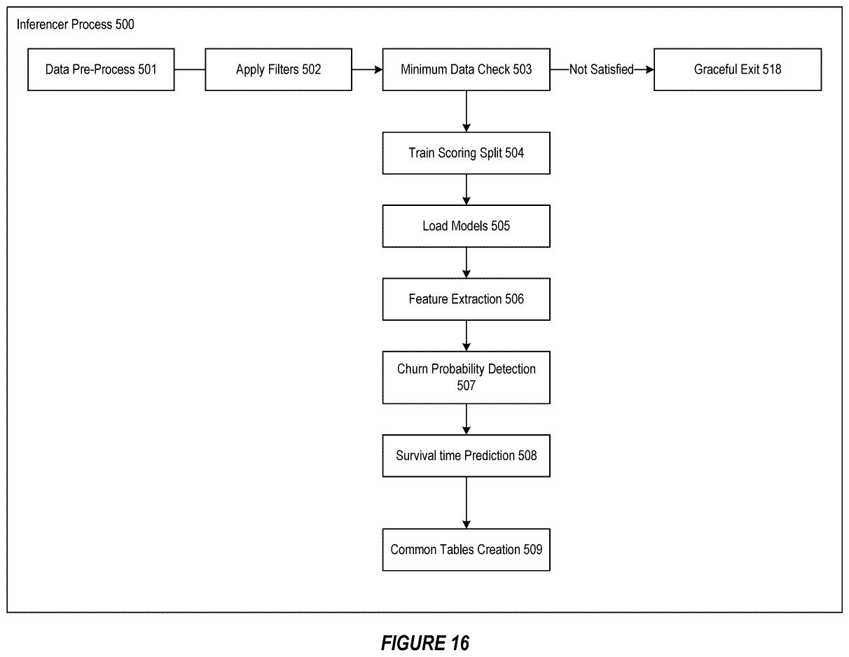

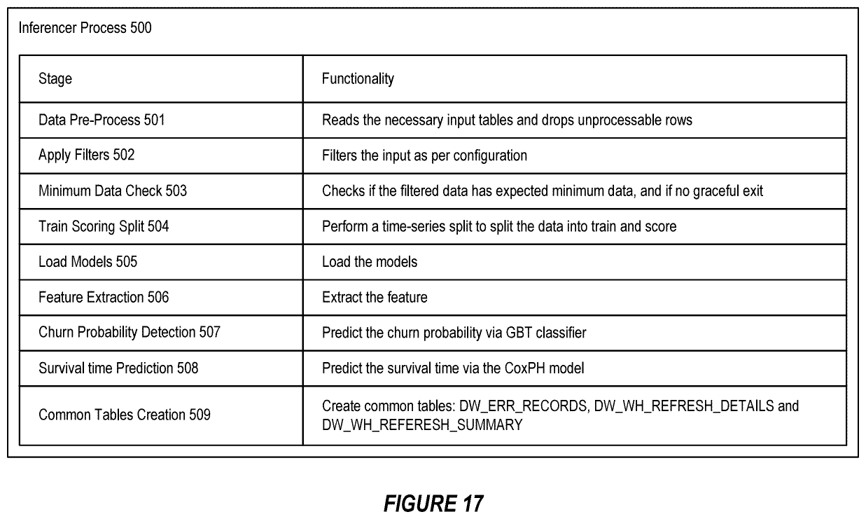

FIGS. 16-17 illustrate an inferencer process, in accordance with an embodiment. As illustrated in FIGS. 16-17, in accordance with an embodiment, the inferencer process can include various stages and associated steps, comprising:

A data pre-process stage (501) wherein the system operates to read the necessary input tables and drops unprocessable rows.

An apply filters stage (502) wherein the system operates to filter the input as per configuration.

A minimum data check stage (503) wherein the system operates to check if the filtered data has expected minimum data, and if not then results in a graceful exit (518).

A train scoring split stage (504) wherein the system operates to perform a time-series split to split the data into train and score datasets.

A load models stage (505) wherein the system operates to load the models.

A feature extraction stage (506) wherein the system operates to extract the features.

A churn probability detection stage (507) wherein the system operates to predict the churn probability via an (e.g., GBT) binary classifier.

A survival time prediction stage (508) wherein the system operates to predict the survival time via the CoxPH model.

A common tables creation stage (509) wherein the system operates to create common tables, for example: DW_ERR_RECORDS, DW_WH_REFRESH_DETAILS and DW_WH_REFRESH_SUMMARY.

The above are provided by way of example; in accordance with an embodiment the inferencer process can similarly include additional and/or different stages that perform additional or other functionalities.

In accordance with an embodiment, a lookback process can be run periodically to determine which customer have churned (for example, in the past week).

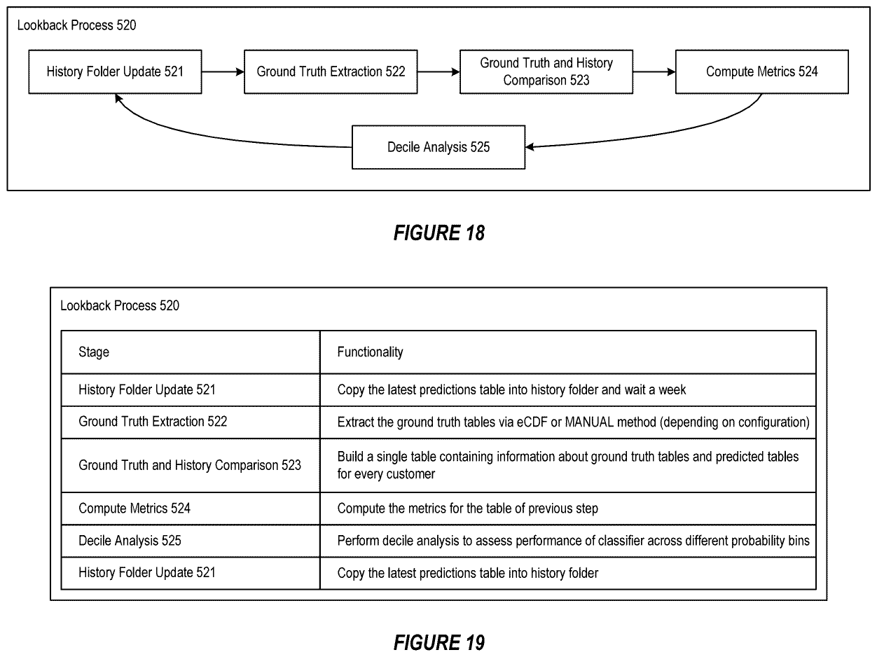

FIGS. 18-19 illustrates a lookback process, in accordance with an embodiment. As illustrated in FIGS. 18-19, in accordance with an embodiment, the lookback process can include various stages and associated steps, comprising:

A history folder update stage (521) wherein the system operates to copy the latest predictions table into a history folder and wait a week.

A ground truth extraction stage (522) wherein the system operates to extract the ground truth tables via an eCDF or MANUAL method (depending on configuration).

A ground truth and history comparison stage (523) wherein the system operates to build a single table containing information about ground truth tables and predicted tables for every customer.

A compute metrics stage (524) wherein the system operates to compute the metrics for the table of the previous step.

A decile analysis stage (525) wherein the system operates to perform a decile analysis to assess performance of the binary classifier across different probability bins.

A history folder update stage (521) wherein the system operates to copy the latest predictions table into the history folder.

The above are provided by way of example; in accordance with an embodiment the lookback process can similarly include additional and/or different stages that perform additional or other functionalities.

### V. Predicted Churn Probability and Predicted Action Window

As described above, in accordance with an embodiment, the customer churn/action determination can be utilized in determining a follow-up action, for example, to aggressively retain, divest, grow, or maintain the customer, as appropriate for the organization's needs or to address its business goals.

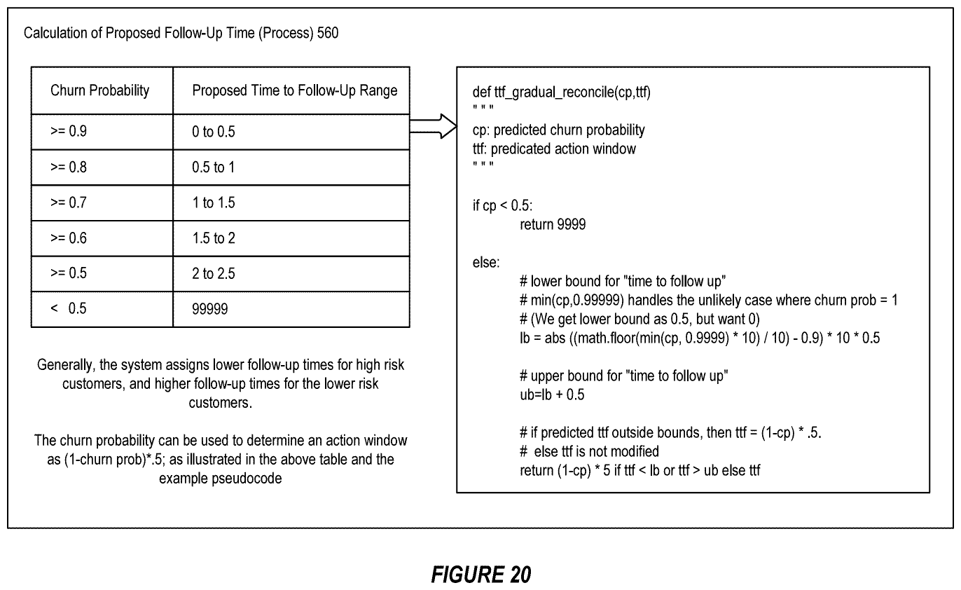

FIG. 20 illustrates a calculation of proposed follow-up time (process), in accordance with an embodiment.

As illustrated in FIG. 20, in accordance with an embodiment, generally, the system (process) 560 assigns lower follow-up times for high risk customers, and higher follow-up times for the lower risk customers. In the example illustrated, the churn probability can be used to determine an action window as (1-churn prob)*. 5; as illustrated in the table and the example pseudocode.

### VI. Binary Classifier Deployment Decider

In accordance with an embodiment, the system includes a deployment decision process, whereby the system can determine whether the model can be deployed, including whether the customer binary classifier is in concordance within a certain range.

Generally the deployment decider or decision process can be run periodically, for example, weekly, wherein the system can determine a Matthews Correlation Coefficient (MCC) for the model. If the determined correlation coefficient is less than a certain number, then the system can elect to either deploy both the binary classifier and the CoxPH models together—or else deploy neither classifier nor model.

In accordance with an embodiment, the algorithm for binary classifier deployment decision can be illustrated as:

binary classifier_deployment_decision = False
If force_deploy is set to True or jobtype == “full”: binary classifier_deployment_decision =
True
else: mcc_decision = decision via MCCDeploymentDecider
model_comparer_decision = decision via MetricsComparisionDeploymentDecider
binary classifier_deployment_decision = mcc_decision and model_comparer_decision
return binary classifier_deployment_decision

In accordance with an embodiment, the algorithm for CoxPH model deployment decision can be illustrated as:

cph_deployment_decision = False
cur_concord = current execution model's concordance
prev_concord = deployed model's concordance
If force_deploy is set to True or jobtype == “full”: cph_deployment_decision = True
elif abs_diff(cur_concord, prev_concord) <= icl.cph_concordance_diff_thresh:
cph_deployment_decision = True
return cph_deployment_decision
final_deployment_decision = binary classifier_deployment_decision and
cph_deployment_decision

In accordance with an embodiment, the algorithm for the deployment decider, and execution of deployment action can be illustrated as:

if final_deployment_decision == True: deploy both CoxPH and binary classifier
else: don't deploy either of them.

As illustrated above, in accordance with an embodiment, the binary classifier and CoxPH models cannot be deployed independently because of potential conflict feature expectations between both of them.

For example, the deployed binary classifier could have been trained on 3 features [A,B,C], while the deployed CoxPH regressor could have been trained on 4 features [A,B,C,D]. In this case, since feature extraction is common for both binary classifier and CoxPH model, the feature “D” would be missing, which would cause CoxPH to crash during inferencing. In order to keep the feature requirement same and avoid potential conflict of feature expectations between binary classifier and CoxPH, we deploy both the models together. This way, the input features extracted from feature extraction pipeline would be same for both CoxPH and binary classifier.

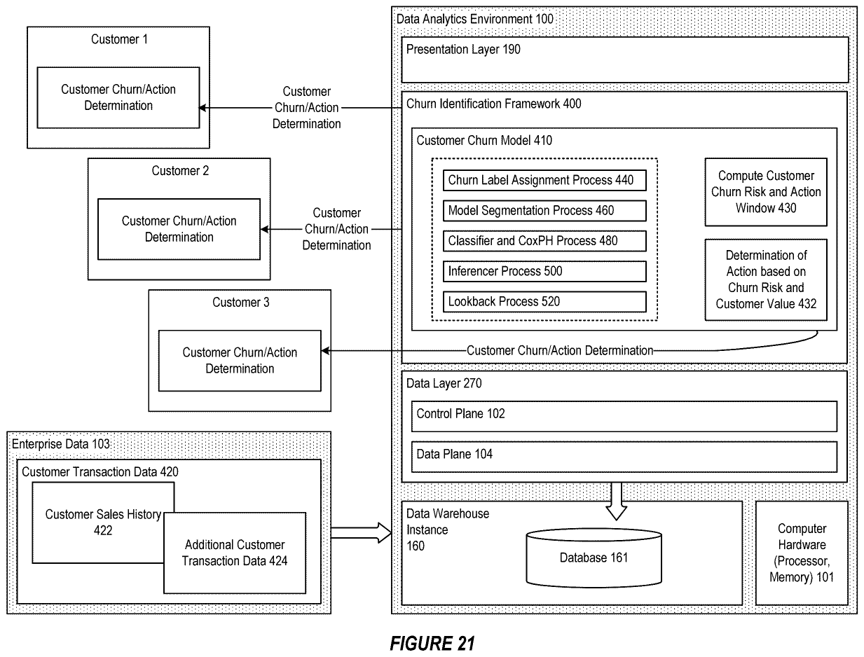

FIG. 21 illustrates the use of a system for automated identification of churned clients or customers, in accordance with an embodiment.

As illustrated in FIG. 21, once the model is deployed, the system can be used to determine a customer churn/action determination associated with a customer, as appropriate for the organization's needs or to address its business goals.

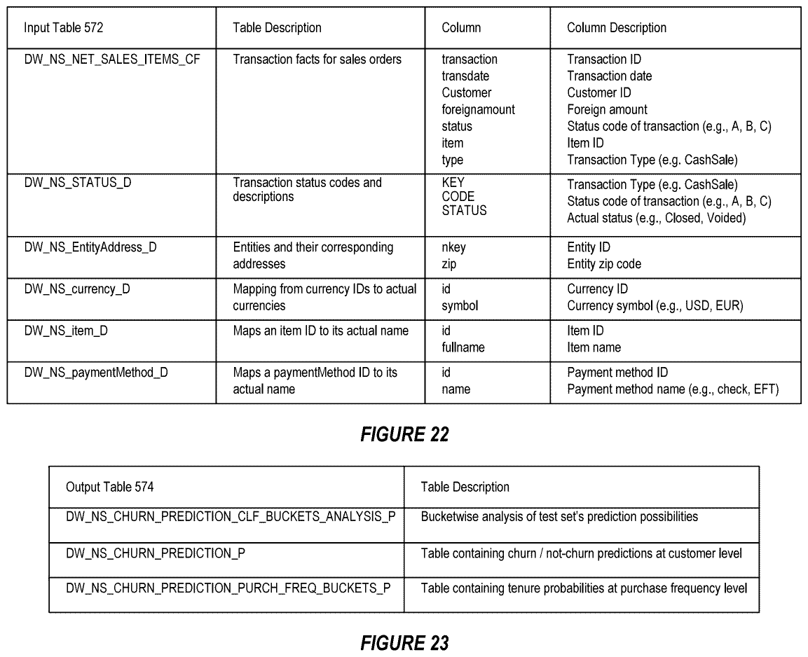

FIGS. 22 and 23 illustrate respectively an example input table, and example output table, in accordance with an embodiment. Example outputs can be tables, which can then be used to create additional dashboards or visualizations

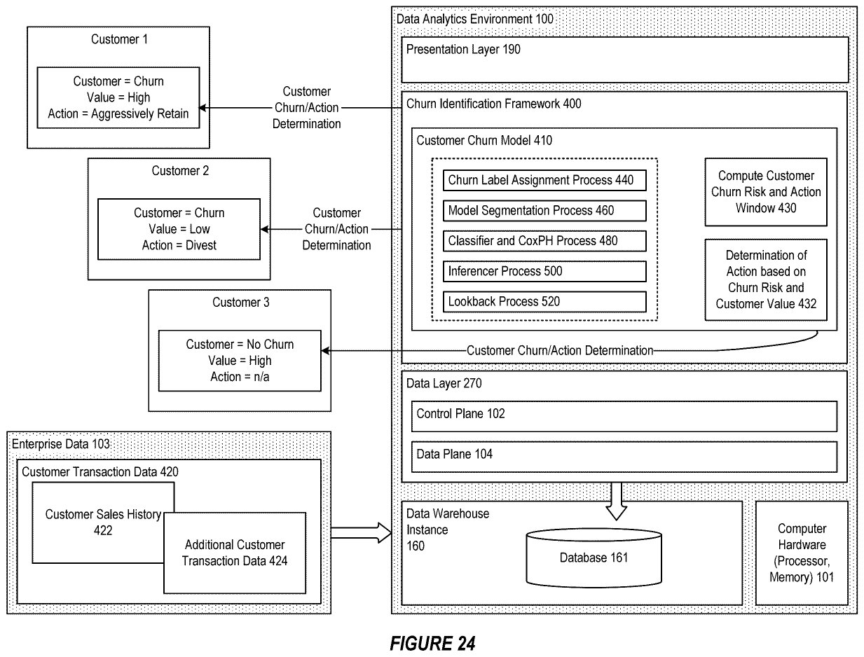

FIG. 24 further illustrates the use of a system for automated identification of churned clients or customers, in accordance with an embodiment.

As illustrated in FIG. 24, for example the system can be used to provide a customer churn/action determination associated with a first customer (Customer=Churn; Value=High; and Action=Aggressively Retain); for a second customer (Customer=Churn; Value=Low; and Action=Divest; and for a third customer (Customer=No Churn; Value=High; and Action=n/a); or other actions as may be appropriate for the organization's needs or to address its business goals.

In accordance with various embodiments, the systems and methods described herein can be implemented using one or more computer, computing device, machine, or microprocessor, including one or more processors, memory and/or computer readable storage media programmed according to the teachings of the present disclosure. Appropriate software coding can readily be prepared by skilled programmers based on the teachings of the present disclosure, as will be apparent to those skilled in the software art.

In some embodiments, the teachings herein can include a computer program product which is a non-transitory computer readable storage medium (media) having instructions stored thereon/in which can be used to program a computer to perform any of the processes of the present teachings. Examples of such storage mediums can include, but are not limited to, hard disk drives, hard disks, hard drives, fixed disks, ROMs, RAMs, EPROMs, EEPROMs, DRAMs, VRAMs, flash memory devices, or other types of storage media or devices suitable for non-transitory storage of instructions and/or data.

The foregoing description has been provided for the purposes of illustration and description. It is not intended to be exhaustive or to limit the scope of protection to the precise forms disclosed. Many modifications and variations will be apparent to the practitioner skilled in the art. For example, although several of the examples provided herein illustrate use with cloud environments such as Oracle Analytics Cloud; in accordance with various embodiments, the systems and methods described herein can be used with other types of enterprise software applications, cloud environments, cloud services, cloud computing, or other computing environments.

The embodiments were chosen and described in order to best explain the principles of the present teachings and their practical application, thereby enabling others skilled in the art to understand the various embodiments and with various modifications that are suited to the particular use contemplated. It is intended that the scope be defined by the following claims and their equivalents.

1. A system for automated identification of churned client entities, comprising:
a computer comprising one or more microprocessors, and a cloud or other computing environment operating thereon, said cloud or other computing environment comprising a plurality of data warehouse instances, wherein the system includes a data pipeline or process that retrieves, for each tenant of a plurality of tenants, data from the tenant's environment, and loads the data to the tenant's data warehouse instance;
wherein the system includes a churn identification framework that performs a method comprising:
determining, based on a customer churn data model and a churn label assignment process, an identification of churned client entities, including:
receiving, via the data pipeline or process, a customer transaction data associated with a plurality of customers;
applying the customer churn data model to the received customer transaction data, to compute a customer churn risk and action window for each of the plurality of customers;
populating a customer action table for each particular customer identifier with an indication of their risk score and action window;
populating a customer value table for each particular customer identifier with an indication of their risk score and a value score; and
automatically identifying or labelling selected customers as churned; and
predicting, based on the customer churn data model, customer action table, and customer value table, one or more of a customer attrition likelihood, and/or a determination of temporal windows for strategic intervention, for particular customers.

2. The system of claim 1, wherein a client entity comprises one or more of a product purchaser or users, cloud service subscriber, or other type of client entity or customer.

3. The system of claim 2, wherein the system operates to predict if a client or customer will churn;
determine a churn timeframe or action window for possible action to address the churn; and/or
automatically identify which clients or customers may have already churned.

4. The system of claim 3, wherein data or information describing churned clients or customers is:
used by the system to automatically determine and/or perform an action directed to particular clients or customers; and/or
returned as one or more displayed reports or other data visualizations.

5. The system of claim 1, wherein the determining an identification of churned client entities is based on an assessment of a customer's direct monetary influence or spend, to take into account each customer's overall size of orders or value amounts.

6. The system of claim 1, wherein model segmentation is based on customer segmentation, and identification of multipliers per customer/model segment for churn cut-off days.

7. The system of claim 1, further comprising use of a model deployment decider to periodically determine when the customer churn data model should be deployed or updated.

8. A method for automated identification of churned client entities, comprising:
providing at a computer system comprising one or more microprocessors, a cloud or other computing environment operating thereon, said cloud or other computing environment comprising a plurality of data warehouse instances, wherein the system includes a data pipeline or process that retrieves, for each tenant of a plurality of tenants, data from the tenant's environment, and loads the data to the tenant's data warehouse instance;
wherein the system performs a method comprising:
determining, based on a customer churn data model and a churn label assignment process, an identification of churned client entities, including:
receiving, via the data pipeline or process, a customer transaction data associated with a plurality of customers;
applying the customer churn data model to the received customer transaction data, to compute a customer churn risk and action window for each of the plurality of customers;
populating a customer action table for each particular customer identifier with an indication of their risk score and action window;
populating a customer value table for each particular customer identifier with an indication of their risk score and a value score; and
automatically identifying or labelling selected customers as churned; and
predicting, based on the customer churn data model, customer action table, and customer value table, one or more of a customer attrition likelihood, and/or a determination of temporal windows for strategic intervention, for particular customers.

9. The method of claim 8, wherein a client entity comprises one or more of a product purchaser or users, cloud service subscriber, or other type of client entity or customer.

10. The method of claim 9, wherein the system operates to predict if a client or customer will churn;
determine a churn timeframe or action window for possible action to address the churn; and/or
automatically identify which clients or customers may have already churned.

11. The method of claim 10, wherein data or information describing churned clients or customers is:
used by the system to automatically determine and/or perform an action directed to particular clients or customers; and/or
returned as one or more displayed reports or other data visualizations.

12. The method of claim 8, wherein the determining an identification of churned client entities is based on an assessment of a customer's direct monetary influence or spend, to take into account each customer's overall size of orders or value amounts.

13. The method of claim 8, wherein model segmentation is based on customer segmentation, and identification of multipliers per customer/model segment for churn cut-off days.

14. The method of claim 8, further comprising use of a model deployment decider to periodically determine when the customer churn data model should be deployed or updated.

15. A non-transitory computer readable storage medium, including instructions stored thereon which when read and executed by a computer system comprising one or more microprocessors cause the system to perform a method comprising:
providing a cloud or other computing environment comprising a plurality of data warehouse instances, wherein the system includes a data pipeline or process that retrieves, for each tenant of a plurality of tenants, data from the tenant's environment, and loads the data to the tenant's data warehouse instance;
determining, based on a customer churn data model and a churn label assignment process, an identification of churned client entities, including:
receiving, via the data pipeline or process, a customer transaction data associated with a plurality of customers;
applying the customer churn data model to the received customer transaction data, to compute a customer churn risk and action window for each of the plurality of customers;
populating a customer action table for each particular customer identifier with an indication of their risk score and action window;
populating a customer value table for each particular customer identifier with an indication of their risk score and a value score; and
automatically identifying or labelling selected customers as churned; and
predicting, based on the customer churn data model, customer action table, and customer value table, one or more of a customer attrition likelihood, and/or a determination of temporal windows for strategic intervention, for particular customers.

16. The non-transitory computer readable storage medium of claim 15, wherein a client entity comprises one or more of a product purchaser or users, cloud service subscriber, or other type of client entity or customer.

17. The non-transitory computer readable storage medium of claim 16, wherein the system operates to predict if a client or customer will churn;
determine a churn timeframe or action window for possible action to address the churn; and/or
automatically identify which clients or customers may have already churned.

18. The non-transitory computer readable storage medium of claim 15, wherein the determining an identification of churned client entities is based on an assessment of a customer's direct monetary influence or spend, to take into account each customer's overall size of orders or value amounts.

19. The non-transitory computer readable storage medium of claim 15, wherein model segmentation is based on customer segmentation, and identification of multipliers per customer/model segment for churn cut-off days.

20. The non-transitory computer readable storage medium of claim 15, further comprising use of a model deployment decider to periodically determine when the customer churn data model should be deployed or updated.
